(19) United States
(12) Patent Application Publication
(10) Pub. No.: US 2023/0382785 A1
(43) Pub. Date: Nov. 30, 2023

(54) SEMICONDUCTOR ELEMENT COATING GLASS AND SEMICONDUCTOR ELEMENT COATING MATERIAL USING SAME

(71) Applicant: Nippon Electric Glass Co., Ltd., Shiga (JP)

(72) Inventor: Masayuki HIROSE, Shiga (JP)

(21) Appl. No.: 18/027,743

(22) PCT Filed: Sep. 21, 2021
(86) PCT No.: PCT/JP2021/034632

§ 371 Date: Mar. 22, 2023

(30) Foreign Application Priority Data
Oct. 13, 2020 (JP) 2020-172271
Feb. 10, 2021 (JP) 2021-019869

(51) Int. Cl. C03C 3/105; C03C 8/24

(52) U.S. Cl. CPC C03C 3/105; C03C 8/24

(57) ABSTRACT

The present invention provides a glass for semiconductor element coating including as a glass composition, in terms of mol %, 55% to 85% of SiO₂, 12% to 40% of PbO, 0.1% to 10% of Al₂O₃, and 0.1% to 6% of GeO₂+Ta₂O₅+Nb₂O₅+Bi₂O₃.

### TECHNICAL FIELD

The present invention relates to a glass for semiconductor element coating and a material for semiconductor element coating using the glass for semiconductor element coating.

### BACKGROUND ART

In a semiconductor element, such as a silicon diode or a transistor, in general, a surface including a P-N junction is coated with a glass. With this configuration, stabilization of the surface of the semiconductor element can be achieved, and deterioration of the characteristics with time can be suppressed.

Examples of the characteristics required for the glass for semiconductor element coating include the following: (1) the glass for semiconductor element coating has a thermal expansion coefficient compatible with a thermal expansion coefficient of the semiconductor element so that no crack or the like occurs due to a difference in thermal expansion coefficient from the semiconductor element; (2) coating can be performed at low temperature (e.g., 900° C. or less, particularly 860° C. or less) to prevent deterioration of the characteristics of the semiconductor element; and (3) the glass for semiconductor element coating is free of an impurity such as an alkali component, which has an adverse influence on the surface of the semiconductor element.

A zinc-based glass such as a ZnO—B₂O₃—SiO₂-based glass, or a lead-based glass, such as a PbO—SiO₂—Al₂O₃-based glass or a PbO—SiO₂—Al₂O₃—B₂O₃-based glass, has heretofore been known as the glass for semiconductor element coating, but from the viewpoint of workability, a lead-based glass, such as a PbO—SiO₂—Al₂O₃-based glass or a PbO—SiO₂—Al₂O₃—B₂O₃-based glass, is currently in the mainstream (see, for example, Patent Literatures 1 and 2).

### CITATION LIST

Patent Literature 1: JP 58-64424 A
Patent Literature 2: JP 11-236239 A

### SUMMARY OF INVENTION

### Technical Problem

In recent years, the following characteristics have been required for the glass for semiconductor element coating in addition to the characteristics (1) to (3): (4) after the coating, a charge quantity in the glass becomes an appropriate amount of negative charge (initial NFB) suitable for the design of semiconductor apparatus; and (5) in a bias test performed by heating and application of a voltage, a change in negative charge quantity in the glass is small. In particular, the characteristic (5) is regarded as important in order to improve reliability of a semiconductor element.

An example of the glass having a small change in negative charge quantity by the bias test is a glass containing zinc as a main component. However, the glass containing zinc as a main component has low acid resistance, and hence there is a risk in that the glass may be eroded by an acid in a manufacturing process for a semiconductor element, and its performance may not be sufficiently exhibited.

Accordingly, the present invention has been made in view of the above-mentioned circumstances, and a technical object of the present invention is to provide a glass for semiconductor element coating having a small change in negative charge quantity in the glass in the bias test and having high acid resistance.

### Solution to Problem

The inventor of the present invention has made extensive investigations, and as a result, has found that the above-mentioned technical object can be achieved by adding, to a PbO—SiO₂—Al₂O₃-based glass, at least any one component selected from GeO₂, Ta₂O₅, Nb₂O₅, and Bi₂O₃. Thus, the finding is proposed as the present invention. That is, according to one embodiment of the present invention, there is provided a glass for semiconductor element coating, comprising, as a glass composition, in terms of mol %, 55% to 85% of SiO₂, 12% to 40% of PbO, 0.1% to 10% of Al₂O₃, and 0.1% to 6% of GeO₂+Ta₂O₅+Nb₂O₅+Bi₂O₃. Herein, the “GeO₂+Ta₂O₅+Nb₂O₅+Bi₂O₃” refers to a total amount of GeO₂, Ta₂O₅, Nb₂O₅, and Bi₂O₃. In addition, the glass for semiconductor element coating according to the one embodiment of the present invention preferably has a content of GeO₂ of from 0.1% to 6%.

As described above, in the glass for semiconductor element coating according to the one embodiment of the present invention, the content range of each component is regulated. With this configuration, the glass having a small change in negative charge quantity in a bias test and having high acid resistance can be obtained. As a result, a semiconductor element can be suitably coated.

According to one embodiment of the present invention, there is provided a material for semiconductor element coating, preferably comprising: 75 mass % to 100 mass % of glass powder formed of the above-mentioned glass for semiconductor element coating; and 0 mass % to 25 mass % of ceramic powder.

In addition, the material for semiconductor element coating according to the one embodiment of the present invention preferably has a thermal expansion coefficient within a temperature range of from 30° C. to 300° C. of from 20×10⁻⁷/° C. to 55×10⁻⁷/° C. Herein, the “thermal expansion coefficient within the temperature range of from 30° C. to 300° C.” refers to a value measured with a push-rod-type thermal expansion coefficient measurement apparatus.

### Advantageous Effects of Invention

According to the present invention, the glass for semiconductor element coating having a small change in negative charge quantity in the glass in the bias test and having high acid resistance can be provided.

### DESCRIPTION OF EMBODIMENTS

A glass for semiconductor element coating of the present invention is characterized by comprising, as a glass composition, in terms of mol %, 55% to 85% of SiO₂, 12% to 40% of PbO, 0.1% to 10% of Al₂O₃, and 0.1% to 6% of GeO₂+Ta₂O₅+Nb₂O₅+Bi₂O₃. The reasons for limiting the content of each component as mentioned above are described below. The expression “%” means “mol %” in the following description of the content of each component unless otherwise stated.

SiO₂ is a component that enhances acid resistance. The content of SiO₂ is preferably from 55% to 85% or from 60% to 80%, particularly preferably from 65% to 75%. When the content of SiO₂ is too small, the acid resistance is liable to be reduced, and vitrification becomes difficult. Meanwhile, when the content of SiO₂ is too large, a firing temperature increases, and hence characteristics of the semiconductor element are liable to be deteriorated in a coating process. In addition, a melting temperature becomes too high, and hence vitrification becomes difficult.

PbO is a component that reduces the firing temperature. The content of PbO is preferably from 12% to 40%, from 14% to 36%, or from 16% to 32%, particularly preferably from 18% to 28%. When the content of PbO is too small, the firing temperature increases, and hence characteristics of the semiconductor element are liable to be deteriorated in the coating process. In addition, the melting temperature becomes too high, and hence vitrification becomes difficult. Meanwhile, when the content of PbO is too large, a thermal expansion coefficient becomes too high, and hence warpage of a wafer becomes large.

Al₂O₃ is a component that stabilizes the glass. The content of Al₂O₃ is preferably from 0.1% to 10%, from 2% to 8%, or from 2% to 7%, particularly preferably from 3% to 6%. When the content of Al₂O₃ is too small, vitrification becomes difficult. Meanwhile, when the content of Al₂O₃ is too large, there is a risk in that the firing temperature may excessively increase.

GeO₂, Ta₂O₅, Nb₂O₅, and Bi₂O₃ are each a component that stabilizes a skeleton of the glass to suppress a change in negative charge quantity by a bias test. The total amount of those components is preferably from 0.1% to 6%, from 0.3% to 5%, or from 0.5% to 4%, particularly preferably from 0.5% to 3.5%. A content of each of those components is also preferably from 0.1% to 6%, from 0.3% to 5%, or from 0.5% to 4%, particularly preferably from 0.5% to 3.5%. It is particularly preferred that the content of GeO₂ be from 0.1% to 6%. When the content of each of those components is too small, the change in negative charge quantity by the bias test becomes large. Meanwhile, when the content of each of those components is too large, electrical characteristics suitable for semiconductor coating become difficult to obtain.

In addition to the above-mentioned components, another component may be introduced. For example, the glass may contain B₂O₃, CaO, SrO, BaO, MnO₂, CeO₂, or Sb₂O₃ at up to 7% (preferably up to 3%). The total amount of the other component is preferably 7% or less, particularly preferably 3% or less.

From the viewpoint of an influence on the semiconductor element, it is preferred that the glass be substantially free of alkali metal oxides (Li₂O, Na₂O, and K₂O), each of which has an adverse influence on the surface of the semiconductor element. Herein, the phrase “substantially free of alkali metal oxides” refers to the content of the alkali metal oxides in the glass composition of less than 0.1 mol %.

The glass for semiconductor element coating of the present invention is preferably a powder form, that is, glass powder. When the glass for semiconductor element coating is processed into glass powder, the surface of the semiconductor element can be easily coated using, for example, a paste method or an electrophoretic coating method.

The glass powder has an average particle diameter D₅₀ of preferably 25 μm or less, particularly preferably 15 μm or less. When the average particle diameter D 50 of the glass powder is too large, pasting becomes difficult. In addition, paste coating by an electrophoretic method also becomes difficult. The lower limit of the average particle diameter D 50 of the glass powder is not particularly limited, but is realistically 0.1 μm or more. The “average particle diameter D 50” refers to a value measured on a volume basis and a value measured by a laser diffraction method.

The glass for semiconductor element coating of the present invention may be obtained by, for example, blending raw material powders of the respective oxide components to form a batch, melting the batch to cause vitrification at about 1,500° C. for about 1 hour, and then forming (and then pulverizing and classifying as required) the resultant.

The material for semiconductor element coating of the present invention contains preferably 75 mass % to 100 mass % of glass powder and 0 mass % to 25 mass % of ceramic powder, more preferably 85 mass % to 100 mass % of glass powder and 0 mass % to mass % of ceramic powder, still more preferably 95 mass % to 100 mass % of glass powder and 0 mass % to 5 mass % of ceramic powder, particularly preferably more than 99 mass % to 100 mass % of glass powder and 0 mass % to less than 1 mass % of ceramic powder. When the ceramic powder is added, the thermal expansion coefficient can be easily adjusted. Meanwhile, when the content of the ceramic powder is too large, softening flowability is impaired, and hence it becomes difficult to coat the surface of the semiconductor element.

The ceramic powder has an average particle diameter D₅₀ of preferably 30 μm or less, particularly preferably 20 μm or less. When the average particle diameter D₅₀ of the ceramic powder is too large, smoothness of the surface of a coating layer is liable to be reduced. The lower limit of the average particle diameter D₅₀ of the ceramic powder is not particularly limited, but is realistically 0.1 μm or more.

The material for semiconductor element coating of the present invention has a thermal expansion coefficient within the temperature range of from 30° C. to 300° C. of preferably from 20×10⁻⁷/° C. to 55×10⁻⁷/° C., particularly preferably from 30×10⁻⁷/° C. to 50×10⁻⁷/° C. When the thermal expansion coefficient falls outside of the above-mentioned ranges, a crack, warpage, or the like is liable to occur due to a difference in thermal expansion coefficient with the semiconductor element.

In the material for semiconductor element coating of the present invention, a softening point is preferably 880° C. or less or 860° C. or less, particularly preferably 840° C. or less. When the softening point is too high, the firing temperature increases, and hence there is a risk in that the characteristics of the semiconductor element may be impaired in the coating process. Herein, the “softening point” refers to a temperature of the fourth inflection point obtained in macro-type differential thermal analysis.

### EXAMPLES

Now, the present invention is described in detail by way of Examples. The following Examples are merely illustrative. The present invention is by no means limited to the following Examples.

Examples (Sample Nos. 1 to 7) and Comparative Examples (Sample Nos. 8 to 11) of the present invention are shown in Table 1.

TABLE 1

| Glass powder | | | | | | | | | | | |
|---|---|---|---|---|---|---|---|---|---|---|---|
| (mol %) | No. 1 | No. 2 | No. 3 | No. 4 | No. 5 | No. 6 | No. 7 | No. 8 | No. 9 | No. 10 | No. 11 |
| SiO₂ | 70.0 | 68.0 | 62.0 | 58.0 | 68.0 | 70.0 | 59.0 | 86.0 | 70.0 | 70.0 | 50.0 |
| PbO | 22.0 | 26.0 | 32.0 | 32.0 | 27.5 | 22.0 | 32.0 | 10.0 | 20.0 | 27.0 | 29.0 |
| Al₂O₃ | 5.0 | 4.0 | 4.0 | 6.0 | 4.0 | 5.0 | 4.0 | 3.0 | 3.0 | 3.0 | 5.0 |
| B₂O₃ | 1.0 | 0.0 | 0.0 | 0.0 | 0.0 | 0.0 | 0.0 | 0.0 | 0.0 | 0.0 | 12.0 |
| GeO₂ | 2.0 | 2.0 | 2.0 | 4.0 | 0.0 | 1.0 | 0.0 | 1.0 | 7.0 | 0.0 | 4.0 |
| Ta₂O₅ | 0.0 | 0.0 | 0.0 | 0.0 | 0.0 | 1.0 | 2.0 | 0.0 | 0.0 | 0.0 | 0.0 |
| Nb₂O₅ | 0.0 | 0.0 | 0.0 | 0.0 | 0.0 | 1.0 | 2.0 | 0.0 | 0.0 | 0.0 | 0.0 |
| Bi₂O₃ | 0.0 | 0.0 | 0.0 | 0.0 | 0.5 | 0.0 | 0.0 | 0.0 | 0.0 | 0.0 | 0.0 |
| Ceramic powder | None | None | None | Cordierite | None | None | None | None | None | None | None |
| (mass %) | | | | 10 | | | | | | | |
| Softening point | 800 | 790 | 770 | 840 | 780 | 800 | 770 | Not melted | 810 | 770 | 740 |
| (° C.) | | | | | | | | | | | |
| Firing | 820 | 810 | 790 | 860 | 810 | 820 | 790 | Not melted | 830 | 790 | 760 |
| temperature | | | | | | | | | | | |
| (° C.) | | | | | | | | | | | |
| Thermal | 44 | 46 | 49 | 47 | 47 | 45 | 49 | Not melted | 45 | 46 | 49 |
| expansion | | | | | | | | | | | |
| coefficient | | | | | | | | | | | |
| (×10⁻⁷/° C.) | | | | | | | | | | | |
| Electrical | ∘ | ∘ | ∘ | ∘ | ∘ | ∘ | ∘ | Not melted | x | ∘ | ∘ |
| characteristics | | | | | | | | | | | |
| Acid resistance | ∘ | ∘ | ∘ | ∘ | ∘ | ∘ | ∘ | Not melted | ∘ | ∘ | x |
| Change in | ∘ | ∘ | ∘ | ∘ | ∘ | ∘ | ∘ | Not melted | ∘ | x | ∘ |
| negative charge | | | | | | | | | | | |
| quantity | | | | | | | | | | | |

Each sample was produced as described below. First, raw material powders were blended so as to have a glass composition in the table to form a batch, and the batch was melted to vitrify at 1,500° C. for 1 hour. Subsequently, the molten glass was formed into a film shape, and then pulverized with a ball mill and classified with a 350-mesh sieve to provide glass powder having an average particle diameter D 50 of 12 μm. In Sample No. 4, 10 mass % of cordierite powder (average particle diameter D 50: 12 μm) was added to the obtained glass powder to form composite powder.

For each sample, the softening point, the firing temperature, the thermal expansion coefficient, the electrical characteristics, the acid resistance, and the change in negative charge quantity were evaluated. The results are shown in Table 1.

The softening point is a temperature of the fourth inflection point obtained in the macro-type differential thermal analysis. The firing temperature is a temperature higher than the softening point by 20° C.

The thermal expansion coefficient is a value measured using a push-rod-type thermal expansion coefficient measurement apparatus within the temperature range of from 30° C. to 300° C.

The electrical characteristics were measured as described below. First, each glass powder was caused to adhere onto a silicon wafer by electrophoresis, and was then fired at a firing temperature in the table for 15 minutes. Aluminum was deposited onto a glass surface of the silicon wafer thus obtained as an electrode, and the negative charge quantity was measured. A case in which the negative charge quantity is from 1×9¹¹/cm² to 10×9¹¹/cm² was marked with Symbol “∘”, and any other case was marked with Symbol “x”.

The acid resistance was evaluated as described below. Each sample was subjected to press molding to have a diameter of mm and a thickness of about 4 mm, and was then fired at a firing temperature in the table to produce a pellet-shaped sample. A change in mass per unit area was calculated from a loss of the mass of the sample after having been immersed in 30% nitric acid at 25° C. for 1 minute. A change in mass per unit area of less than 1.0 mg/cm² was marked with Symbol “∘”, and a change in mass per unit area of 1.0 mg/cm² or more was marked with Symbol “x”.

The change in negative charge quantity was evaluated as described below. First, each glass powder was caused to adhere onto a silicon wafer by electrophoresis, and was then fired at a firing temperature in the table for 15 minutes. Aluminum was deposited onto a glass surface of the silicon wafer thus obtained as an electrode. Next, the silicon wafer was loaded into a thermostatic chamber at 150° C., and kept for 24 hours under a state in which a voltage of 400 V was applied between a back surface of the silicon wafer and the electrode, and then the electrical characteristics were evaluated. A case where the measured change in negative charge quantity of less than 5×10¹¹/cm² was marked with Symbol “∘”, and any other case was marked with Symbol “x”.

As apparent from Table 1, each of Sample Nos. 1 to 7 had a thermal expansion coefficient of from 44×10⁻⁷/° C. to 49×10⁻⁷/° C. and a firing temperature of 860° C. or less, and evaluations of electrical characteristics and acid resistance and negative charge quantity change were also satisfactory. Accordingly, Sample Nos. 1 to 7 may each be suitable as a material for semiconductor element coating.

Meanwhile, no vitrification occurred in Sample No. 8 because the melting temperature was too high. In Sample No. 9, satisfactory electrical characteristics were not obtained. In Sample No. 10, the change in negative charge quantity was too large. In Sample No. 11, the acid resistance was low.

1. A glass for semiconductor element coating, comprising, as a glass composition, in terms of mol %, 55% to 85% of SiO₂, 12% to 40% of PbO, 0.1% to 10% of Al₂O₃, and 0.1% to 6% of GeO₂+Ta₂O₅+Nb₂O₅+Bi₂O₃.

2. The glass for semiconductor element coating according to claim 1, wherein the glass has a content of GeO₂ of from 0.1% to 6%.

3. A material for semiconductor element coating, comprising:
75 mass % to 100 mass % of glass powder formed of the glass for semiconductor element coating of claim 1; and
0 mass % to 25 mass % of ceramic powder.

4. The material for semiconductor element coating according to claim 3, wherein the material for semiconductor element coating has a thermal expansion coefficient within a temperature range of from 30° C. to 300° C. of from 20×10⁻⁷° C. to 55×10⁻⁷° C.
